(19) United States
(12) Patent Application Publication
(10) Pub. No.: US 2016/0016152 A1
(43) Pub. Date: Jan. 21, 2016

(54) Corrosion Resistant Catalysts for Decomposition of Liquid Monopropellants

(71) Applicant: Sienna Technologies, Inc., Woodinville, WA (US)

(72) Inventor: Ender Savrun, Seattle, WA (US)

(21) Appl. No.: 14/488,070

(22) Filed: Sep. 16, 2014

Related U.S. Application Data
(63) Continuation-in-part of application No. 13/115,814, filed on May 25, 2011, now Pat. No. 9,149,795.

(51) Int. Cl. B01J 23/63

(52) U.S. Cl. CPC B01J 23/63

(57) ABSTRACT

Ceramic catalyst carriers that are mechanically, thermally and chemically stable in a ionic salt monopropellant decomposition environment and high temperature catalysts for decomposition of liquid high-energy-density monopropellants are disclosed. The ceramic catalyst carrier has excellent thermal shock resistance, good compatibility with the active metal coating and metal coating deposition processes, melting point above 1800° C., chemical resistance to steam, nitrogen oxides and acids, resistance to sintering to prevent void formation, and the absence of phase transition associated with volumetric changes at temperatures up to and beyond 1800° C.

### PRIORITY CLAIM

This application is a continuation-in-part of U.S. application Ser. No. 13/115,814, filed May 25, 2011.

### FIELD OF THE INVENTION

This invention relates generally to high temperature, corrosion resistant catalysts for decomposition of liquid high-energy-density ionic salt monopropellants.

### BACKGROUND OF THE INVENTION

Thrust is produced in a monopropellant thruster, or reaction engine, in the following stages: (1) A monopropellant fluid (liquid or gaseous) that is usually pressurized is injected onto a catalyst bed. (2) When the monopropellant comes in contact with the catalyst it decomposes, or ignites. Decomposition of the monopropellant may occur in one reaction or in multiple sequential reactions. Then (3) the decomposition products are exhausted through the exit cone or nozzle to create thrust. The thrust, or specific impulse, is dependant on many variable including engine design, size, and energy produced by propellant decomposition.

A typical monopropellant catalyst consists of discrete active metal particles dispersed on a ceramic carrier, or substrate. The active metal particles catalyze, or reduce the activation energy for, monopropellant decomposition upon contact. The purpose of the catalyst substrate is to (i) increase the surface area of active metal to provide more sites for propellant decomposition and (i) stabilize the active metal particles, i.e., prevent them from migrating or sintering, which leads to particle growth and/or loss of active metal surface area. During thruster operation, the substrate is exposed to the propellant and intermediate species that form during propellant decomposition as well as decomposition products that are extremely corrosive, particularly at elevated temperatures (>1000° C.). This leads to degradation of the substrate, followed by catalyst deactivation. A long life monopropellant catalyst must be composed of a substrate that is resistant to corrosion from the propellant and its decomposition products and intermediate species and resistant to degradation under thruster operating conditions.

Reduced toxicity high-energy-density ionic salt monopropellants, including but not limited to monopropellants containing an oxidizer such as hydroxylammonium nitrate (HAN, [HO—NH₃⁺]NO₃⁻) and one or more fuels in highly concentrated solutions containing water, ethanol or a suitable solvent or without a solvent are described as replacements for hydrazine-based propellants. The new monopropellants, which will hereinafter sometimes be referred to as ionic salt monopropellants or high-energy-density ionic salt monopropellants and which include HAN-based ionic salt monopropellants, offer lower toxicity, lower flammability, lower vapor pressure, lower freezing-point temperature, and higher density-specific impulse than hydrazine-based monopropellants.

Liquid monopropellants, including but not limited to HAN-based ionic salt monopropellants, can be decomposed by passing them over a solid catalyst bed. The catalyst decreases the activation energy required for monopropellant decomposition, thus allowing for combustion at lower temperatures than required for pure thermal decomposition. However, the decomposition and combustion reactions degrade the catalyst. As a result, a typical monopropellant thruster can only be fired for a limited number of pulses, or until the catalyst fails due to loss of catalytic mass or loss of catalyst activity as described above.

The high-adiabatic-decomposition-temperatures of the described HAN-based ionic salt monopropellants render conventional catalysts ineffective when applied to these formulations. The adiabatic flame temperature of the HAN-based ionic salt monopropellants exceeds 1800° C., whereas hydrazine possesses an adiabatic flame temperature of only 900° C. In addition, decomposition of the HAN-based ionic salt monopropellants produces highly oxidizing species such as oxygen (O₂), acidic species such as HNO₃, and water vapor that are highly corrosive to metals as well as ceramics such as alumina (Al₂O₃) that are typically used in conventional catalysts.

Use of high-energy-density ionic salt monopropellants, including ionic salt monopropellants, as a replacement for the current state-of-art hydrazine monopropellant can potentially increase thruster performances. However, use of hot burning high-energy-density ionic monopropellants requires use of catalysts, chamber materials, and bed plates in the thruster/reaction engine that can survive in the monopropellant decomposition environment at temperatures exceeding 1600° C. and as high as 2000° C.

Conventional, prior art catalysts such as Ir/Al₂O₃, Pt/Al₂O₃, LCH-210, LCH-207, LCH-227, Shell 405 or S-405 that were developed for use with hydrazine cannot withstand the higher operating temperatures and the more corrosive environment encountered in decomposing high-energy-density HAN-based ionic salt monopropellants.

ZrO₂ is an amphoteric refractory oxide and has demonstrated a good acid resistance in HAN thruster environments. However, it suffers from a destructive tetragonal-to-monoclinic phase transformation due to a volumetric change of 3%-5% or more associated with this phase transformation. Repeated heating and cooling cycles, such as those encountered in a rocket engine, would result in a complete loss of the mechanical integrity of ZrO₂.

Stabilizers, typically MgO, CaO, Y₂O₃, La₂O₃ or CeO₂, are added in necessary concentrations to fully stabilize ZrO₂ in the cubic phase or to partially stabilize ZrO₂ in tetragonal phase to provide transformation toughening and prevent the spontaneous tetragonal-to-monoclinic phase transformation and destruction of the material that would otherwise occur upon heating and cooling over a given temperature range as described above. However, these stabilizers are all basic and are susceptible to acid-base reactions in acidic environments such as those encountered in rocket engines operating with ionic salt-based monopropellants. Partially stabilized (t-ZrO₂) or fully stabilized (c-ZrO₂) goes through an aging process where the basic stabilizers come out of solid solution and subsequently react with the acidic species in the HAN thruster environment. This acid-base reaction effectively removes the basic stabilizer from the zirconia and thus increases the rate of precipitation of the stabilizers from ZrO₂ and accelerates the aging and destabilization of ZrO₂. The sequence of precipitation and removal by acid-base reaction prevents the basic stabilizer, once precipitated, from going back into solid solution with ZrO₂ upon heating and re-stabilizing the material. In addition, some of the conventional stabilizers mentioned here, such as MgO and CaO, are extremely hydrophilic and thus after precipitation from ZrO₂ may potentially be removed from the material in the presence of water vapor or steam that can exist in the thruster environment.

Problems observed during rocket engine tests containing conventional catalysts with new monopropellants include excessive sintering of catalyst, void formation, increase in pressure drop, fracturing of catalyst granules, fine formation, fragmentation of the catalyst granules due to thermal shock, leaching of the catalyst by acids, and rapid loss of catalyst activity. Catalysts such as LCH-237 and Sienna's SSC-0103 that consist of an Ir coated ZrO₂-based carrier containing traditional stabilizers such as CeO₂, Y₂O₃, or CaO can provide over 30 minutes of lifetime but some missions require longer lifetimes. The lifetime of these catalysts are limited by the aging of the stabilized ZrO₂ carriers, and leaching of the stabilizers by acids or steam during service that leads to fracturing of catalyst granules, fine formation, fragmentation of the catalyst granules due to thermal shock, and rapid loss of catalyst activity.

Ceramic materials that have been evaluated as catalyst carriers for use with HAN-based ionic salt monopropellants include transition metal oxides such as Al₂O₃, TiO₂, ZrO₂, CeO₂—ZrO₂, Y₂O₃—ZrO₂ (Kirchnerova, J., Klvana, D. (2000) “Design Criteria for High Temperature Combustion Catalysts,” Catalysis Lett, Vol. 67, p. 175.), refractory carbides and nitrides such as SiC and Si₃N₄ (Rodrigues, J. A. J et al., (1997), “Nitride and Carbide of Molybdenum and Tungsten as Substitutes of Iridium for the Catalyst Used for Space Communication”, Catalysis Lett., Vol. 45, P. 1-3.), transition metal-based and alkaline earth-based perovskites (Savrun, E. and Schmidt, E. W., (2001), “High Temperature Catalyst for Nontoxic Monopropellant”, Air Force Research Laboratories SBIR Phase I Final Report, AFRL-PR-ED-TR-2001-0012; Savrun, E. et al., “Novel Catalysts for HAN/HEHN Based Monopropellants”, NASA Glenn Research Center SBIR Phase I final Report, NAS3-02025) and transition metal substituted lanthanum-strontium hexaaluminates (Tejuca, L. G., Fierro, J. L. G., and Tascon, J. M. D., (1989) “Structure and Reactivity of Perovskite-Type Oxides”, Adv. Catalysis, Vol. 36, P. 237). The combined stabilizing effects and corrosion resistance of In₂O₃ in ZrO₂ are cited in U.S. Pat. No. 5,288,205 to Jones, R., 1994, “India-stabilized Zirconia Coating for Composites,” and in the following reference: Jones, R. L. and Mess, D. 1992, “India as a Hot Corrosion-Resistant Stabilizer for Zirconia,” Journal of American Ceramics Society, volume 75, pages 1818-1821. The combined stabilizing effects and corrosion resistance of Sc₂O₃ in ZrO₂ are cited in Jones, R. L., 1989 “Scandia-stabilized Zirconia for Resistance to Molten Vanadate-sulfate Corrosion,” Surface and Coatings Technology, volume 39/40, pages 89-96. The combined stabilizing effects and corrosion resistance of SnO₂ in ZrO₂ are cited in U.S. Pat. No. 5,312,585 to Jones, R. L., 1994, “Corrosion Inhibition in High Temperature Environment”. The combined stabilizing effects of Ga₂O₃ in ZrO₂ and its resistance to water or steam are cited in U.S. Pat. No. 5,279,995 to Hiroaki Tanaka et al., 1994, “Zirconia Ceramics.”

### SUMMARY OF THE INVENTION

Ceramic catalyst carriers that are mechanically, thermally and chemically stable in a HAN-based ionic salt monopropellant decomposition environment, catalysts comprising the ceramic catalyst carriers and a catalytically active coating, and methods of producing the stabilized ceramic catalyst carrier and of producing the ceramic catalyst are disclosed and described in the various preferred embodiments of the invention below.

The ceramic catalyst carriers of the present invention are acid resistant fully or partially stabilized zirconia-based or hafnia-based ceramics with high mechanical, chemical and thermal stability in the rocket engine environment and therefore are suitable for preparation of catalysts for the decomposition of ionic salt (including HAN-based) monopropellants. The ceramic catalyst carriers of the present invention have various advantages, particularly when compared to previous materials, including excellent thermal shock resistance, good compatibility with catalytically active coatings (e.g., active metal coatings) and coating deposition processes, high thermal stability up to and beyond 1800° C., chemical resistance to steam, nitrogen oxides and nitric acid, resistance to sintering to prevent void formation, and the absence of phase transitions associated with volumetric changes at temperatures up to and greater than 1800° C. In particular, the zirconia-based or hafnia-based ceramic catalyst carriers of the present invention utilize non-conventional metal oxide stabilizers that are less susceptible to corrosion, leaching, and/or aging (destabilization) in the presence of acids and/or steam than conventional stabilizers such as MgO, CaO, Y₂O₃, CeO₂, or La₂O₃ or other lanthanides; thus resulting in zirconia-based or hafnia-based ceramic with improved chemical stability and resistance to aging. In one version, the preferred lanthanides may include one of Pr₂O₃, Eu₂O₃, and Dy₂O₃, and Eu₂O₃.

In one embodiment, the present invention provides ceramic catalyst carriers comprising of partially or fully stabilized zirconia (ZrO₂) or hafnia (HfO₂) containing one or more of the following stabilizers: Cr₂O₃, Sc₂O₃, In₂O₃, SnO₂, Ga₂O₃, Sb₂O₃. The resistance of stabilized zirconia (In₂O₃—ZrO₂, Sc₂O₃—ZrO₂ SnO₂—ZrO₂ or Ga₂O₃—ZrO₂) to acids such as nitric acid and nitrogen oxides that form in ionic salt based propellant combustion chambers at high temperatures is not discussed in the cited references, nor is use of In₂O₃—ZrO₂, Sc₂O₃—ZrO₂, SnO₂—ZrO₂ or Ga₂O₃—ZrO₂ as catalyst substrates or in catalysts for propulsion technologies. Any reference to the use of Cr₂O₃ or Sb₂O₃ as stabilizers to increase corrosion resistance of stabilized zirconia was not found in the patent literature.

In one embodiment, the present invention provides ceramic catalyst carriers comprising of partially or fully stabilized zirconia (ZrO₂) or hafnia (HfO₂) containing one or more of the following stabilizers described above such as Cr₂O₃, Sc₂O₃, In₂O₃, SnO₂, Ga₂O₃, Sb₂O₃, and one or more of a conventional stabilizer such as MgO, Y₂O₃, CaO, La₂O₃, CeO₂, or other lanthanides.

In one embodiment, the ceramic catalyst carriers described here are produced by traditional ceramic processing techniques such as reactive sintering, sol-gel, or co-precipitation.

In another embodiment, the ceramic catalyst carriers described here are produced in the form of spheres using a technique described in Savrun and Sawhill, 2010, “High Temperature Catalysts for Decomposition of Liquid Monopropellants and Method for Producing the Same,” U.S. patent application Ser. No. 12/942,364, the contents of which are incorporated by reference.

In one embodiment, the partially or fully stabilized zirconia (ZrO₂) or hafnia (HfO₂) catalyst carrier materials described here are used as a wash-coat or coating on a carrier that is comprised of another high temperature ceramic material, such as a perovskite with the formula ABO₃ or non stoichiometric perovskite with the formula AB_{1+y}O_{3+2y}, described in U.S. patent application Ser. No. 12/942,364 that has a lower resistance to corrosion and/or aging in the present of acids, steam, ionic propellants, or ionic propellant combustion products.

In an additional embodiment, the present invention provides catalysts comprising the ceramic catalyst carrier as described above and an active metal coating which comprises about 0.5% to about 40% by weight of one or more metals selected from the group consisting of platinum, rhodium, ruthenium, rhenium, osmium and iridium.

In certain embodiments, the active metal coating of the catalyst comprises iridium, iridium/rhodium alloy, iridium/osmium alloy, or combinations thereof.

The ceramic catalyst carriers of the present invention are particularly useful for the preparation of catalysts for the decomposition of high-energy-density ionic salt monopropellants, including HAN-based ionic salt monopropellants, in the reaction engines of satellites and rockets. However, it should be understood that the ceramic catalyst carriers and catalysts of the present invention can be used with other propellants, including hydrazine and hydrazine derivatives and bipropellants, nitrous oxide-based monopropellants and bipropellants, and for other applications, including decomposition of nitrogen oxide compounds (e.g., NOₓ compounds or N₂O) in automotive or gas abatement applications.

In yet further embodiments, the stabilized ceramic is used in other parts of the rocket engine which must also survive highly corrosive, oxidizing environments at temperatures of 1600° C.-2000° C. without losing their mechanical integrity. These conditions are achieved in the reaction chamber, or thrust chamber, as well as in the catalyst bed plate, in a rocket engine using hot-burning, high-energy density ionic salt monopropellants.

The thrust chamber and bed plate materials of a rocket engine using high-energy density ionic salt monopropellants must have the following properties: (i) thermal and chemical stability, corrosion resistance, and oxidation resistance in a combustion environment at temperatures of 1600° C.-2000° C., (ii) thermal shock resistance to withstand sudden temperature changes, and (iii) mechanical strength and fracture toughness to handle stresses from vibration, chamber pressure, and flight acceleration both at room temperature and high temperature.

Fully or partially stabilized zirconia and hafnia materials under this invention can be used to construct thrust chambers and bed plates for rocket engines that operate on high-energy-density monopropellants because of their high thermochemical stability in oxidizing environments and their high mechanical strength at high temperatures. These materials can also be used as a liner or coating for metallic thrust chambers and bed plates. These materials may also be used to construct thrust chambers, components inside thruster chambers, or as thrust chamber liners in bipropellant or solid propellant thrusters.

### BRIEF DESCRIPTION OF THE DRAWINGS

FIG. 1 is a schematic diagram of a monopropellant thruster engine in which a catalyst bed is supported by a bed plate in the thruster/reaction chamber. The monopropellant thruster engine includes thruster/catalyst chamber 100. Within the chamber 100 is a catalyst bed 200, supported on a catalyst bed plate 101. Propellant P passes down a feed line 102, and an injector 103 injects it into the chamber 100. Upon reaction with the catalyst, it decomposes, heating and expanding. The products of decomposition pass through the bed plate 101, through a throat 104, and out a exit cone or nozzle 105, generating thrust in the direction of the arrow T.

FIG. 2 is an enlarged schematic of the thruster/catalyst chamber in FIG. 1 that shows the monopropellant impinging on the catalyst bed and igniting and decomposing to create thrust. As is shown in FIG. 2, a propellant P is injected into the thruster/catalyst chamber where it contacts the catalyst bed 200. The catalyst bed 200 can be made up of many individual catalyst granules 201. In an embodiment, the catalyst granules 201 include a catalyst carrier or substrate 202 which is coated with a catalytically active metal 203. In an embodiment of the invention, the catalyst carrier or substrate 202 consists of a ceramic support, e.g., partially or fully stabilized zirconia or hafnia such as described more fully below, and catalytically active metal 203 may include iridium particles.

FIG. 3 is an X-ray diffraction pattern for scandia (Sc₂O₃) stabilized zirconia (ZrO₂) granules with 10 mol % Sc₂O₃ (90% ZrO₂-10% Sc₂O₃) described in Example 1; and

FIG. 4 is the phase diagram for the ZrO₂—Sc₂O₃ system. 90% ZrO₂-10% Sc₂O₃ is an example of an acid resistant stabilized zirconia system described in this patent.

### DETAILED DESCRIPTION OF EXEMPLARY EMBODIMENTS OF THE INVENTION

Stabilizing ZrO₂ with an oxide that is (i) more acidic, (ii) less soluble in acids, and/or (iii) less hydrophilic significantly improves the stability of stabilized ZrO₂ catalyst substrates in acidic, steam containing HAN thruster environments.

We have identified oxides that can be used as stabilizers for ZrO₂ in catalyst substrates with higher chemical stabilities than the conventional stabilizers. These substrates also have thermochemical stability up to and beyond 1800° C. for use in HAN thruster environments. The stabilizers identified in this invention for use in ZrO₂-based catalyst substrates for use in HAN thrusters include SnO₂, Sb₂O₃, Ga₂O₃, In₂O₃, Cr₂O₃, and Sc₂O₃, and combinations thereof, for example ZrO₂—Sc₂O₃—In₂O₃. The stabilizers identified in this invention may be used together with one or more conventional stabilizers such as MgO, Y₂O₃, CaO, La₂O₃, CeO₂ and other lanthanides, for example, ZrO₂—Sc₂O₃—CaO.

Use of one more of the identified oxides, for example, SnO₂, Sb₂O₃, Ga₂O₃, In₂O₃, Cr₂O₃, and/or Sc₂O₃, in combination with or as replacements for conventional stabilizers in ZrO₂, may increase its resistance to corrosion by acids and provide longer lifetimes during use with HAN-based ionic salt monopropellants that can form acidic species such as nitric acid (HNO₃) during combustion. In addition, the higher acid resistance of the identified materials may prevent or reduce degradation that may occur during deposition of the active metal layer via wet impregnation or other wet chemical methods that employ use of an acidic metal salt solution deposition process. For example, deposition of iridium (Ir) can be carried out via wet impregnation using dihydrogen hexachloroiridic acid (H₂IrCl₆.6H₂O) aqueous solutions that contain a high concentration of hydrogen chloride (HCl) acid. With poor acid resistance such as CaO-stabilized ZrO₂, the basic oxide CaO may react with HCl or water during deposition of the active metal layer via wet impregnation. This is consistent with the observation that upon placing ZrO₂-based catalyst substrates containing CaO in H₂IrCl₆.6H₂O or HCl aqueous solutions the pH of the solutions rises significantly.

Use of one more of the identified oxides in this patent, for example, SnO₂, Sb₂O₃, Ga₂O₃, In₂O₃, Cr₂O₃, and/or Sc₂O₃, in combination with or as replacements for conventional stabilizers in ZrO₂, may increase its resistance to aging thus increase its resistance to destabilization in water, acid, or steam environments.

In certain particular embodiments, the present invention provides catalysts comprising the ceramic catalyst carrier as described above containing ZrO₂ as the base material in which HfO₂ is used as the base material or the base material is comprised of both ZrO₂ and HfO₂.

In other embodiments, the present invention provides catalysts comprising the stabilized ZrO₂ or HfO₂ catalyst substrates described here as a wash-coat or coating on another type high temperature ceramic catalyst support.

In certain particular embodiments, the present invention provides catalysts comprising the ceramic catalyst carrier as described above and an active metal coating which comprises about 0.5% to about 40% by weight of one or more metals selected from the group consisting of platinum, rhodium, ruthenium, osmium, rhenium, and iridium.

In certain particular embodiments, the active metal coating of the catalyst comprises iridium or iridium/rhodium, iridium/osmium, iridium/osmium/rhodium alloys.

In other embodiments, the present invention provides catalysts comprising the ceramic catalyst carrier as described above and a catalytically active ceramic material.

Various methods can be used to apply catalytically active materials to the surface of the ceramic catalyst carriers of the present invention. For example, with respect to active metal coatings, wet deposition processes such as incipient wetness techniques, wet soaking techniques, ion exchange techniques and wet spraying techniques using salt solutions of the metal can be used. Other useful techniques for the application of active metal coatings include, for example, chemical vapor deposition and sputtering.

One exemplary method for the deposition of iridium on the ceramic catalyst carriers of the present invention involves wet deposition of an iridium chloride salt solution followed by heat-treatment at about 300° C. to about 400° C. in air to stabilize the iridium chloride salt, and reduction in flowing hydrogen (H₂) or a gaseous mixture containing H₂ at temperatures in the range of about 400° C. to about 1000° C., to form Ir particles. It is desirable that the reduction temperature be about 500° C. to about 600° C.

Various methods can be used to prepare the ceramic catalyst carriers and catalysts of the present invention including reactive sintering, sol-gel, co-precipitation, and the method described in U.S. patent application Ser. No. 12/942,364 for fabricating spherical ceramic catalyst carrier granules.

### EXAMPLES

### Example 1

Production of scandia stabilized zirconia (ZrO₂—Sc₂O₃) granules with 10% mol Sc₂O₃, using flash-freeze process and reactive sintering process described in U.S. patent application Ser. No. 12/942,364 for fabricating spherical ceramic catalyst carrier granules.

Necessary amounts of Sc₂O₃ and ZrO₂ powders to give a mole ratio of ZrO₂/Sc₂O₃=90/10 and total solids loading of approximately 15% vol were dispersed in water by ball-milling using an ammonium polyacrylate type dispersant. After milling is complete, a water-soluble binder such as polyvinyl alcohol was added to the slurry at a concentration of 3.0% by weight to the powder (solids). The milled slurry was dispensed into a cold hexane bath held at a temperature of −60° C. using a spray atomizer and feed pressure of 2 psi while keeping the spray nozzle at least 2 cm above the height of the hexane. The flash-frozen granules were then removed from the hexane and placed in a freeze-dryer sample chamber held at a temperature of −20° C. to insure the granules did not melt. The pressure inside the freeze-dryer chamber was reduced to <150 mtorr vacuum while maintaining the given temperature, then the temperature was slowly increased to room temperature while under vacuum causing the water in the granules to sublime. The resulting precursor (“green”) granules were removed from the freeze-dryer and placed in a muffle furnace for binder removal. The binder was removed from the green granules by heating to 200° C. to 550° C. in flowing air. The granules are immediately transferred to an open tube furnace and heat-treated at temperatures >1400° C. to facilitate reactive sintering and formation of scandia stabilized zirconia granules with 10 mol % Sc₂O₃.

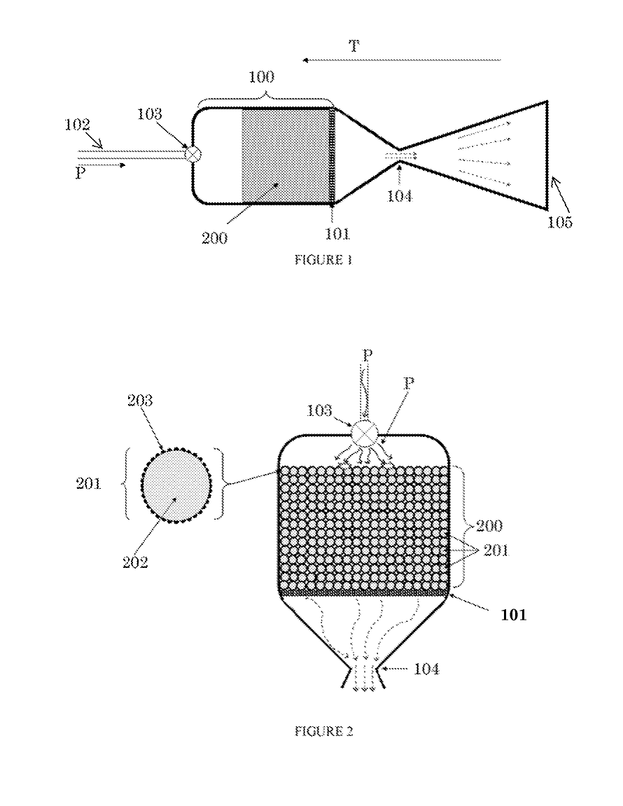

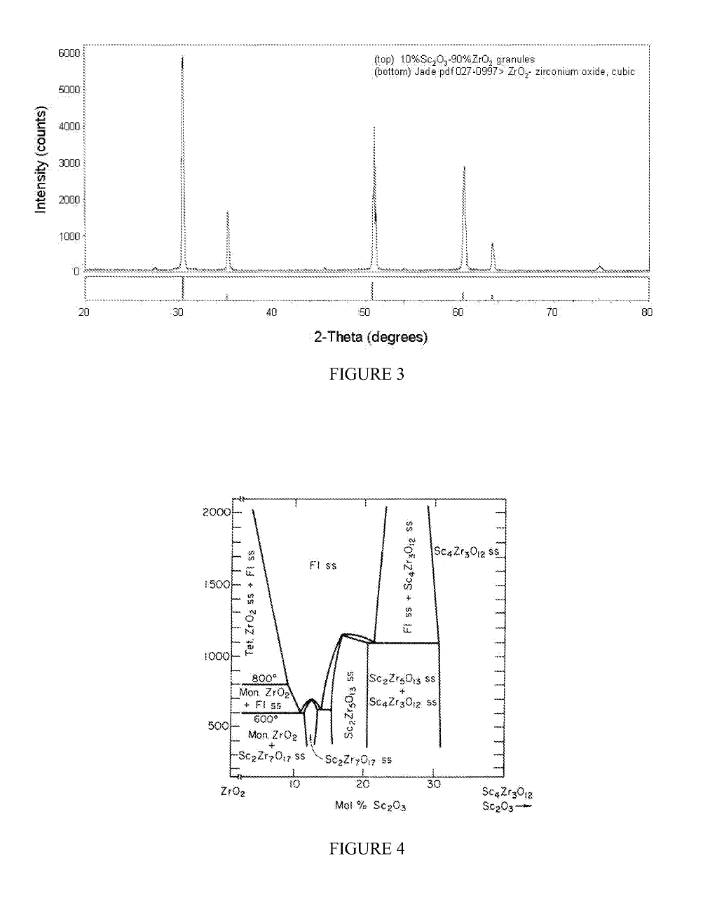

The X-ray diffraction pattern for scandia stabilized zirconia granules with 10 mol % Sc₂O₃ described in this example in FIG. 1 shows they are a fully stabilized cubic zirconia. This is consistent with the phase diagram for ZrO₂—Sc₂O₃ in FIG. 2 that shows 10% Sc₂O₃-90% ZrO₂ is cubic fluorite solid solution (Fl ss) above approximately 700° C.

### Example 2

Coating of ZrO₂—Sc₂O₃ granules from Example 1 with iridium (Ir).

The ZrO₂—Sc₂O₃ granules produced in accordance with Example 1 herein above were coated with iridium (Ir) via wet deposition using a dihydrogen hexachloroiridic acid solution to give a loading of 5%-10% by weight Ir.

While various embodiments of the invention have been illustrated and described, as noted above, many changes can be made without departing from the spirit and scope of the invention. Also, some method steps may be performed in a different order than that described or concurrently with other steps. Accordingly, the scope of the invention is not limited by the disclosure of the particular embodiments disclosed herein. Instead, the invention should be determined entirely by reference to the claims that follow. All publications and patents mentioned herein are incorporated herein by reference in their entirety.

The embodiments of the invention in which an exclusive property or privilege is claimed are defined as follows:

1. A ceramic-metal catalyst comprising:
a ceramic selected from the group consisting of zirconia (ZrO₂), hafnia (HfO₂), and a mixture thereof; and
at least one stabilizer selected from the group consisting of Cr₂O₃, Sc₂O₃, In₂O₃, SnO₂, Ga₂O₃, and Sb₂O₃; and
a catalytically active metal,
wherein the metal-ceramic catalyst is formed as a plurality of granules formed from the ceramic, the stabilizer, and the catalytically active metal.

2. The ceramic-metal catalyst of claim 1, further comprising at least one second stabilizer, the second stabilizer comprising one or more of MgO, Y₂O₃, CaO, or a lanthanide.

3. The ceramic-metal catalyst of claim 2, wherein the lanthanide is selected from a group consisting of CeO₂, Nd₂O₃, Yb₂O₃, and Sm₂O₃.

4. The ceramic-metal catalyst of claim 2, wherein the lanthanide is selected from a group consisting of Pr₂O₃, Eu₂O₃, Dy₂O₃, and Eu₂O₃.

5. The ceramic-metal catalyst of claim 1, wherein the at least one stabilizer is selected from the group consisting of Ga₂O₃ and Sb₂O₃.

6. The ceramic-metal catalyst of claim 5, wherein the at least one stabilizer is Ga₂O₃.

7. The ceramic-metal catalyst of claim 1, wherein the plurality of stabilized ceramic granules are housed within a catalyst bed of a rocket engine.

8. A ceramic-metal catalyst comprising:
a stabilized ceramic catalyst carrier matrix formed from a plurality of ceramic particles, the ceramic particles comprising:
a ceramic catalyst carrier selected from the group consisting of zirconia (ZrO₂) and hafnia (HfO₂) and a mixture thereof;
at least one stabilizer selected from the group consisting of Cr₂O₃, Sc₂O₃, In₂O₃, SnO₂, Ga₂O₃, and Sb₂O₃; and
a catalytically active metal positioned in the ceramic catalyst carrier matrix.

9. The ceramic-metal catalyst of claim 8, further comprising at least one second stabilizer, the second stabilizer comprising one or more of MgO, Y₂O₃, CaO, or a lanthanide.

10. The ceramic-metal catalyst of claim 8 wherein the lanthanide is selected from a group consisting of Pr₂O₃, Eu₂O₃, and Dy₂O₃, and Eu₂O₃.

11. The ceramic-metal catalyst of claim 8 wherein the at least one stabilizer is selected from the group consisting of Ga₂O₃ and Sb₂O₃.

12. The ceramic-metal catalyst of claim 8 wherein the catalytically active metal is dispersed on the surface of the plurality of stabilized ceramic particles, the particles forming the catalyst carrier matrix.

13. The ceramic-metal catalyst of claim 8 wherein the catalytically active metal is dispersed within the stabilized ceramic catalyst carrier matrix.

14. The ceramic-metal catalyst of claim 8 wherein the catalytically active metal comprises at least one metal selected from the group consisting of platinum, rhodium, ruthenium, rhenium, osmium, iridium, iridium/rhodium alloy, and iridium/osmium alloy.

15. The ceramic-metal catalyst of claim 8 wherein the catalytically active metal comprises at least one of iridium, iridium/rhodium alloy, and iridium/osmium alloy.

16. The ceramic-metal catalyst of claim 8, wherein the plurality of particles forming the stabilized ceramic catalyst carrier matrix is housed within a catalyst bed.

17. A ceramic-metal catalyst for use with a monopropellant in a rocket engine having a thrust chamber, the metal-ceramic catalyst being housed within the thrust chamber and comprising:
a stabilized ceramic catalyst carrier matrix formed as a plurality of ceramic particles comprising:
a ceramic catalyst carrier selected from the group consisting of zirconia (ZrO2) and hafnia (HfO2) and a mixture thereof;
at least one stabilizer selected from the group consisting of Cr2O3, Sc2O3, In2O3, SnO2, Ga2O3, and Sb2O3; and
a catalytically active metal within the matrix.

18. The ceramic-metal catalyst of claim 18, further comprising at least one second stabilizer, the second stabilizer comprising one or more of MgO, Y2O3, CaO, or a lanthanide.

19. The ceramic-metal catalyst of claim 18 wherein the catalytically active metal is dispersed on the surface of the plurality of stabilized ceramic particles, the particles forming the catalyst carrier matrix.
